(19) United States
(12) Patent Application Publication
(10) Pub. No.: US 2009/0082491 A1
(43) Pub. Date: Mar. 26, 2009

(54) ENVIRONMENTALLY DEGRADABLE POLYMERIC BLEND AND PROCESS FOR OBTAINING AN ENVIRONMENTALLY DEGRADABLE POLYMERIC BLEND

(75) Inventors: Jefter Fernandes Nascimento, Sao Paulo City (BR); Wagner Mauricio Pachekoski, Sao Carlos (BR); Jose Augusto Marcondes Agnelli, Sao Carlos (BR)

Correspondence Address: DARBY & DARBY P.C., P.O. BOX 770, Church Street Station, New York, NY, 10008-0770, US

(73) Assignee: PHB INDUSTRIAL S.A., Serrana - SP (BR)

(21) Appl. No.: 12/280,407

(22) PCT Filed: Feb. 23, 2007
(86) PCT No.: PCT/BR07/00044

§ 371 Date: Sep. 15, 2008

(30) Foreign Application Priority Data
Feb. 24, 2006 (BR) PI0600681-7

(51) Int. Cl. C08L 67/00; B29C 45/00; C08L 97/02; C08L 51/00; C08K 3/34; C08K 3/22

(52) U.S. Cl. 524/14; 264/328.1; 524/539; 524/504; 524/413; 524/400

(57) ABSTRACT

The present invention refers to an environmentally degradable polymeric blend, comprising biodegradable polymers defined by polyhydroxybutyrate (PHB) or copolymers thereof and Polycaprolactone (PCL) and, optionally, at least one additive defined by a filler, nucleant, thermal stabilizer, processing aid, with the purpose of preparing an environmentally degradable polymeric blend. According to the production process described herein, the blend resulting from the mixture of the biodegradable polymers, PHB and PCL, and at least one additive, can be utilized in the manufacture of injected food packages, injected packages for cosmetics, tubes, technical pieces and several injected products.

### FIELD OF THE INVENTION

The present invention refers to a polymeric blend based upon a biodegradable polymer defined by polyhydroxybutyrate (PHB) or copolymers thereof and polycaprolactone (PCL) and, optionally, at least one additive, such as: a filler, nucleant, thermal stabilizer, processing aid additive, with the objective of preparing an environmentally degradable polymeric blend.

According to the process described herein, the blend resulting from the mixture of the biodegradable polymers, PHB and PCL, and at least one additive, can be used in the manufacture of injected food packages, injected packages for cosmetics, tubes, technical pieces and several injected products.

### PRIOR ART

There are known from the prior art different biodegradable polymeric materials used for manufacturing garbage bags and/or packages, comprising a combination of degradable synthetic polymers and additives, which are used to improve the obtention and/or properties thereof, ensuring a wide application.

Polymeric blend is the term adopted in the technical literature about polymers to represent the physical or mechanical mixtures of two or more polymers, so that between the molecular chains of the different polymers only exists secondary intermolecular interaction or in which there is not a high degree of chemical reaction between the molecular chains of the different polymers. Many polymeric blends are used as engineering plastics, with applications mainly in the automobilistic and electromechanical industries, and in countless other industrial fields. Among the polymers that form these polymeric blends, it is highly predominant the use of conventional polymers.

Recently, it has been noticed the increasing interest in employing biodegradable polymers, i.e. polymers that are environmentally correct. However, most patents of biodegradable polymers refer to the production of polymers, and only a small number relates to the application thereof in polymeric blends and the biodegradability of these new polymeric materials.

In the attempt of creating alterations in the characteristics of processability and/or mechanical properties, some modifications of the polyhydroxybutyrate—PHB have been proposed, such as the formation of polymeric blends with other biodegradable polymers, associated or not with other possibilities of additivation. Such developments are often carried out in laboratory processes and/or use manual molding techniques, without industrial productivity.

Accordingly, some citations have been found regarding miscible and compatible polymeric blends, formed by PHB with the polymers: polyvinylacetate—PVAc, polyepichloroidrine—PECH, polyvinylydene fluoride—PVDF, poly(R,S) 3-hydroxybutyrate copolymer, polyethylene glycol-P(R,S-HB-b-EG), and polymethylmethacrylate—PMMA. There are also citations of unmiscible and compatible polymeric blends, based on the mixture of PHB with: poly(1,4 butylene adipate)—PBA, ethylpropylene rubbers (EPR); ethylenevinylacetate (EVA), modified EPR (grafted with succinic anhydride (EPR-g-SA) or with dibutyl maleate (EPR-DEM)), modified EVA containing —OH group (EVAL) and polycyclo-hexyl methacrylate—PCHMA, poly(lactic acid)—PLA and polycaprolactone—PCL.

On the other hand, the citations found about production process, compositions and applications of polymeric blends constituted by the pair PHB-PCL differ from the novel characters of the present invention in the following aspects:
technology of obtaining compatible polymeric blends based on the PHB-PCL, since in the developed process, a modular twin-screw extruder is used, having screw profile of designed based on the rheologic behavior of the PHB and PCL polymers, which permits a satisfactory dispersion and an optimum distribution of the polymers, generating an adequate and stable morphology and resulting in PHB/PCL polymeric blends with higher physicomechanical performance.
possibility of greatly varying the contents of the constitutive polymers, producing tailored polymeric materials from intrinsic characteristics of these components.
possibility of modifying these polymeric blends with other additives, such as natural fibers and natural fillers and lignocellulosic residues.
utilization of two methods with commercial viability: extrusion process for obtaining the PHB/PCL polymeric blends and injection molding for obtaining products.

### SUMMARY OF THE INVENTION

It is a generic object of the present invention to provide a polymeric blend to be used in different applications, such as for example, in the manufacture of injected food packages, injected packages for cosmetics, tubes, technical pieces and several injected products, by using a biodegradable polymer defined by polyhydroxybutyrate or copolymers thereof; a poly aliphatic aromatic copolyester and at least one additive, thus allowing the production of environmentally degradable materials.

According to a first aspect of the invention, there is provided a polymeric blend, comprising a biodegradable polymer defined by polyhydroxybutyrate or copolymers thereof; an aliphatic-aromatic copolyester; and, optionally, at least one additive consisting of: plasticizer of natural origin, such as natural fibers; natural fillers; thermal stabilizer; nucleant; compatibilizer; surface treatment additive; and processing aid.

In accordance with a second aspect of the present invention, a process is provided for preparing the blend described above, comprising the steps of:

a) pre-mixing the polymers (PHB) of copolymers thereof and polycaprolactone (PCL) and at least one additive; b) drying said mixture; extruding the mixture to obtain granulation; and c) injection molding the extruded and granulated material to manufacture the injected packages, as well as other injected products.

### DETAILED DESCRIPTION OF THE INVENTION

Within the class of biodegradable polymers, the structures containing ester functional groups are of great interest, mainly due to its usual biodegradability and versatility in physical, chemical and biological properties. Produced by a large variety of microorganisms as a source of energy and carbon, the polyalkanoates (polyesters derived from carboxylic acids) can be synthesized either by biological fermentation or chemically.

Polyhydroxybutyrate—PHB is the main member of the class of polyalkanoates. Its great importance is justified by the reunion of 3 major factors: it is 100% biodegradable, water resistant and also a thermoplastic polymer, allowing it to be used in the same applications as the conventional thermoplastic polymers. Formula 1 shows the PHB structure.

Structural formula of (a) 3-hydroxybutyric acid and (b) Poly(3-hydroxybutyric acid)—PHB.

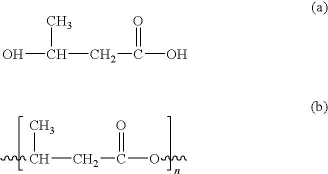

PHB was discovered by Lemognie in 1925 as a source of energy and of carbon storage in microorganisms, such as bacteria Alcaligenis euterophus, in which, under optimum conditions, above 80% of the dry weight is PHB.

Nowadays, the bacterial fermentation is the major production source of polyhydroxybutyrate, in which the bacteria are fed in reactors with butyric acid or fructose and left to grow, and after some time the bacterial cells are extracted from PHB with a suitable solvent.

In Brazil, PHB is produced in industrial scale by PHB Industrial S/A, the only Latin America Company that produces polyhydroxyalkanoates (PHAs) from renewable sources. The production process of the polyhydroxybutyrate basically consists of two steps:
Fermentative step: in which the microorganisms metabolize the sugar available in the medium and accumulate the PHB in the interior of the cell as source of reserve.
Extractive step: in which the polymer accumulated in the interior of the microorganism cell is extracted and purified until a solid and dry product is obtained.

The project developed by PHB Industrial S.A allowed to use sugar and/or molasses as a basic component of the fermentative medium, fusel oil (organic solvent—byproduct of the alcohol manufacture) as extraction system of the polymer synthesized by the microorganisms, and also the use of the excess sugarcane bagasse to produce energy (vapor generation) for these processes. This project permitted a perfect vertical integration with the maximum utilization of the byproducts generated in the sugar and alcohol manufacture, providing processes that utilize the so-called clean and ecologically correct technologies.

Through a process of production similar to that of the PHB, it is possible to produce a semicrystalline bacterial copolymer of 3-hydroxybutyrate with random segments of 3-hydroxyvalerate, known as PHBV. The main difference between both processes is based on the addition of the proprionic acid in the fermentative medium. The quantity of proprionic acid in the bacteria feeding is responsible for the control of hydroxyvalerate—HV concentration in the copolymer, enabling to vary the degradation time (which can be from some weeks to several years) and certain physical properties (molar mass, crystallinity degree, surface area, for example). The composition of the copolymer further influences the melting point (which can range from 120 to 180° C.), and the characteristics of ductility and flexibility (which are improved with the increase of HV concentration). Formula 2 shows the basic structure of PHBV.

### Basic Structure of PHBV.

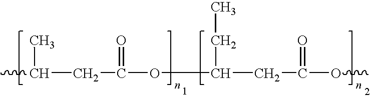

According to some studies, the PHB shows a behavior with some ductility and maximum elongation of 15%, tension elastic modulus of 1.4 GPa and notched IZOD impact strength of 50 J/m soon after the injection of the specimens. Such properties modify with time and stabilize in about one month, with the elongation reducing from 15% to 5% after 15 days of storage, reflecting the fragilization of the material. The tension elastic modulus increases from 1.4 GPa to 3 GPa, while the notched Izod impact strength reduces from 50 J/m to 25 J/m after the same period of storage. Table 1 shows some properties of the PHB compared to the isostatic Polypropylene (commercial polypropylene).

TABLE 1
Comparison of the PHB and the PP properties.

| Properties | PHB | PP |
|---|---|---|
| % of crystallinity degree | 80 | 70 |
| Average Molar mass (g/mol) | 4 × 10⁵ | 2 × 10⁵ |
| Melting Temperature (° C.) | 175 | 176 |
| Glass Transition Temperature (° C.) | −5 | −10 |
| Density (g/cm³) | 1.2 | 0.905 |
| Modulus of Flexibility (GPa) | 1.4-3.5 | 1.7 |
| Tensile strength (MPa) | 15-40 | 38 |
| % of Elongation at break | 4-10 | 400 |
| UV Resistance | good | poor |
| Solvent Resistance | poor | Good |

The degradation rates of articles made of PHB or its Poly (3-hydroxybutyric-co-hydroxyvaleric acid)-PHBV copolymers, under several environmental conditions, are of great relevance for the user. The reason that makes them acceptable as potential biodegradable substitutes for the synthetic polymers is their complete biodegradability in aerobic and anaerobic environments to produce CO₂/H₂O/biomass and CO₂/H₂O/CH₄/biomass, respectively, through natural biological mineralization. This biodegradation usually occurs via surface attack by bacteria, fungi and algae. The actual degradation time of the biodegradable polymers and, therefore, of the PHB and PHBV, will depend upon the surrounding environment, as well as upon the thickness of the articles.

PHB or PHBV copolymer may or may not contain plasticizers of natural origin, specifically developed for plasticizing these biodegradable polymers.

The plasticizing additive, when present, can be a vegetable oil “in natura” (as found in nature) or derivative thereof, ester or epoxy, from soybean, corn, castor-oil plant, palm, coconut, peanut, linseed, sunflower, babasu palm, palm kernel, canola, olive, carnauba wax, tung, jojoba, grape seed, andiroba, almond, sweet almond, cotton, walnuts, wheatgerm, rice, macadamia, sesame, hazelnut, cocoa (butter), cashew nut, cupuacu, poppy and their possible hydrogenated derivatives, being present in the blend composition in a mass proportion lying from about 2% to about 30%, preferably from about 2% to about 15% and, more preferably, from about 5% to about 10%.

Said plasticizer further presents a fatty composition ranging from: 45-63% of linoleates, 2-4% of linoleinates, 1-4% of palmitates, 1-3% of palmitoleates, 12-29% of oleates, 5-12% of stearates, 2-6% of miristates, 20-35% of palmistate, 1-2% of gadoleates and 0.5-1.6% of behenates.

### Polycaprolactone—PCL

The polycaprolactone—PCL is a synthetic biodegradable aliphatic polyester, which is a tough and flexible crystalline polymer.

### Chemical Structure of the Polycaprolactone—PCL

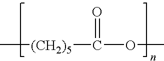

The PCL is synthetically prepared, generally by ring-opening polymerization of the ε-caprolactone. The PCL has low glass transition temperature (from −60 to −70° C.) and melting temperature (58-60° C.). The slow crystallization rate causes variation in the crystallinity with time. Until recently, the PCL has not been employed in significant quantities for applications as a biodegradable polymer, due to the high cost thereof. Recently, these cost barriers have been overcome by mixing the PCL with other biodegradable polymers and/or other products, such as starch and wood flour.

The polycaprolactone—PCL is degraded by fungi, and such biodegradation occurs in two stages: a first step of abiotic hydrolytic scission of the chains of high molar mass, with the subsequent enzymatic degradation, for microbial assimilation.

Due to its low melting temperature, the pure PCL polymer is of difficult processability. Nevertheless, its facility to increase the molecular mobility in the polymeric chain makes its use as plasticizer possible. Its biocompatibility and its “in vivo” degradation (much slower than other polyesters), also enable its use in the medical field for systems of long periods of time (from 1 to 2 years). Although it is not produced from raw material of renewable sources, the polycaprolactone—PCL is completely biodegradable, either pure or composted with biodegradable materials.

PCL blends with other biodegradable polymers are also of potential use in medical field, such as for example the PHB/PCL blends.

The polycaprolactone—PCL has been also widely studied as a substrate for biodegradation and as a matrix in the controlled drug delivery systems.

Modifiers and Other Additives that can be Incorporated in the PHB/PCL Polymeric Blends
Natural fibers: the natural fibers that can be used in the developed process herein are: sisal, sugarcane bagasse, coconut, piasaba, soybean, jute, ramie, and curaua (Ananas lucidus), present in the composition in a mass proportion ranging from about 5% to about 70% and, more preferably, from about 10% to about 60%.
Natural fillers: the lignocellulosic fillers that can be used in the developed process are: wood flour or wood dust, starches and rice husk, present in the composition in a mass proportion ranging from about 5% to about 70% and, more preferably, from about 10% to about 60%.
Processing aid/dispersant: optional utilization of processing aid/dispersant specific for compositions with thermoplastics, in the amount of 1% in relation to the total content of modifiers. The processing aid used herein is the product Struktol, commercialized by Struktol, present in the composition in a mass proportion from about 0.01% to about 2%, preferably from about 0.05% to about 1% and, more preferably, from about 0.1% to about 0.5%.
Compatibilizers can be of the type: polyolefine functionalized or grafted, with maleic anhydride, ionomer based on ethylene acrylic acid or ethylene methacrylic acid copolymers, neutralized with sodium (trademark Surlin from DuPont), present in the composition in a mass proportion lying from about 0.01% to about 2%, preferably from about 0.05% to about 1%.
Nucleants: boron nitride or HPN®, from Milliken.
Other additives of optional use: thermal stabilizers—primary antioxidant and secondary antioxidant, pigments, ultraviolet stabilizers of the oligomeric HALS type (sterically hindered amine), present in the composition in a mass proportion lying from about 0.01% to about 2%, preferably from about 0.05% to about 1% and, more preferably, from about 0.1% to about 0.5%.
surface treatment agents can be of the type: silane, titanate, zirconate, epoxy resin, stearic acid and calcium stearate, present in a mass proportion lying from about 0.01% to about 2%.

### Production Process of the Polymeric Blends

### Developed Methodology and Formulations of the Polymeric Blends

The generalized methodology developed for the preparation of the PHB/Polycaprolactone—PCL polymeric blends is based on five steps, which can be compulsory or not, depending upon the specific objective desired for a particular biodegradable mixture.

The steps for preparing the PHB/PCL polymeric blends are:

a. Defining the formulations
b. Drying biodegradable polymers and the other optional components
c. Pre-mixing the components
d. Extruding and granulating
e. Injection molding for the manufacture of several products

### Description of the Steps

a. Defining the Formulations:

Table 2 shows the main formulations of the PHB/PCL polymeric blends.

TABLE 2
Formulations of the PHB/PCL polymeric blends, including
the modifiers and other optional additives

| | CONTENT RANGE |
|---|---|
| COMPONENTS | (% IN MASS) |
| Biodegradable polymer 1: PHB or | 10 a 90% |
| PHBV, containing or until to 6% of | |
| plasticizer of natural origin | |
| Biodegradable polymer 2: | 10 a 90% |
| Polycaprolactone - PCL | |
| Natural fiber 1* | 0 a 30% |
| Natural fiber 2** | |
| Lignocellulosic filler*** | 0 a 30% |
| Processing aid/Dispersant/ | 0 a 0.5% |
| Nucleant | |
| Thermal stabilization system - | 0 a 0.3% |
| Primary antioxidant:secondary | |
| antioxidant (1:2) | |
| Pigments | 0 a 2.0% |
| Ultraviolet stabilizers | 0 a 0.2% |

*sisal or sugarcane bagasse or coconut or piasaba or soybean or jute or ramie or curaua (Ananas lucidus)
**any of the natural fibers employed, except the fiber selected as natural fiber 1.
***wood flour, starches or rice husk (or straw).

b. Drying the Biodegradable Polymers and the Other Optional Components

The biodegradable polymers, PHB and PCL, and other possible modifiers should be adequately dried prior to the processing operations that will result in the production of the polymeric blends. The residual moisture content should be quantified by Thermogravimetry or other equivalent analytical technique.

c. Pre-Mixing the Components

Biodegradable polymers and other optional additives, except the fiber(s), can be physically premixed and homogenized in mixers of low rotation, at room temperature, for uniformizing the length of the natural fiber and surface treating the natural fibers and/or the natural fillers.

d. Extruding and Granulating

The extrusion process is responsible for the structural formation of the PHB/PCL polymeric blends. That is to say, the obtention of the morphology of the polymeric system, including distribution, dispersion and interaction of the biodegradable polymers, is defined in this step of the process. In the extrusion step, granulation of the developed materials also occurs.

In the extrusion step it is necessary to use a modular co-rotating twin screw extruder with intermeshing screws, from Werner & Pfleiderer or the like, containing gravimetric feeders/dosage systems of high precision.

The main strategic aspects of the distribution, dispersion, and interaction of the biodegradable polymers in the polymeric blend are: the development of the profile of the modular screws, considering the rheologic behavior of the PHB and the PCL; the feeding place of the optional natural modifiers; the temperature profile; the extruder flowrate.

The profile of the modular screws, i.e., the type, number, distribution sequence and adequate positioning of the elements (conveying and mixing elements) determine the efficiency of the mixture and consequently the quality of the polymeric blend, without causing a processing severity that might provoke degradation of the constituent polymers.

Modular screw profiles were used with pre-established configurations of conveying elements, controlling the pressure field and kneading elements for controlling both the melting and the mixture (dispersion and distribution of the biodegradable polymers). These groups of elements are vital factors to achieve an adequate morphological control of the structure, optimum dispersion and satisfactory distribution of both PHB and PCL.

The optional natural modifiers can be introduced directly into the feed hopper of the extruder and/or in an intermediary position (fifth barrel), with the PHB and PCL in the melted state.

The temperature profile of the different heating zones, notably the feeding region and the head region at the outlet of the extruder, as well as the flowrate controlled by the rotation speed of the screws are also highly important variables.

Table 3 shows the processing conditions through extrusion for the compositions of the PHB/PCL polymeric blends.

The granulation for obtaining the granules of the PHB/PCL polymeric blends is carried out in common granulators, which however can allow an adequate control of the speed and number of blades so that the granules present dimensions to allow achieving a high productivity in the injection molding.

TABLE 3
Extrusion conditions for obtaining the PHB/PCL polymeric
blends

| | Temperature (° C.) | | | | | | | Speed |
|---|---|---|---|---|---|---|---|---|
| | Zone 1 | Zone 2 | Zone 3 | Zone 4 | Zone 5 | Zone 6 | Head | (rpm) |
| PHB/PCL | 110-125 | 125-145 | 125-145 | 125-145 | 125-145 | 125-145 | 140-155 | 140-200 |
| Polymeric | | | | | | | | |
| blends | | | | | | | | |

e. Injection Molding for the Manufacture of Several Products

In the injection molding it is necessary the utilization of an injecting machine operated through a computer system to effect a strict control on the critical variables of this processing method.

Table 4 shows the processing conditions through injection for the compositions of the PHB/PCL polymeric blends.

The integration of the injection molding in the developed process is satisfactorily obtained by controlling the critical variables: melt temperature, screw speed during the dosage and counter pressure. If there is not a strict control of said variables (conditions presented in Table 4), the high shearing inside the gun will give rise to the formation of gases, hindering the uniformization of the dosage, jeopardizing the filling operation of the cavities.

Special attention should also be given to the project of the molds, mainly relative to the dimensional aspect, when using the molds with hot chambers, in order to maintain the polymeric blend in the ideal temperature, and when using submarine channels, as a function of the high shearing resulting from the restricted passage to the cavity.

TABLE 4
Injection conditions of the PHB/PCL polymeric blends

| | Feeding | Zone 2 | Zone 3 | Zone 4 | Zone 5 | |
|---|---|---|---|---|---|---|
| Thermal | 155-160 | 160-175 | 160-175 | 160-175 | 160-175 | ° C. |
| Profile | | | | | | |

| Material | PHB/PCL Polymeric blends | |
|---|---|---|
| Injection Pressure | 450-800 | bar |
| Injection Speed | 20-40 | cm³/s |
| Commutation | 450-800 | bar |
| Packing pressure | 300-550 | bar |
| Packing time | 10-15 | s |
| Dosage speed | 8-15 | m/min |
| Counter pressure | 10-60 | bar |
| Cooling time | 30-60 | s |
| Mold temperature | 20-50 | ° C. |

### EXAMPLES OF PROPERTIES OBTAINED FOR SOME COMPOSITIONS OF THE POLY(HYDROXYBUTYRATE)—PHB/POLYCAPROLACTONE—PCL POLYMERIC BLENDS

There are listed below examples of polymeric blends consisting of Poly(hydroxybutyrate)—PHB/Polycaprolactone—PCL CAPA, whereas Tables 5-8 present the characterization of these polymeric blends:

### Example 1

Polymeric blend 75% Poly(hydroxybutyrate)—PHB/25% Polycaprolactone—PCL CAPA (Table 5).

### Example 2

Polymeric blend 50% Poly(hydroxybutyrate)—PHB/50% Polycaprolactone—PCL CAPA (Table 6).

### Example 3

Polymeric blend 45% Poly(hydroxybutyrate)—PHB/15% Polycaprolactone—PCL CAPA, modified with 40% of wood dust or wood flour (Table 7).

### Example 4

Polymeric blend 30% Poly(hydroxybutyrate)—PHB/30% Polycaprolactone—PCL CAPA, modified with 40% of wood dust or wood flour (Table 8).

TABLE 5
Properties of the 75% PHB/25% PCL polymeric blend

| | Property/Test | Test method | Value |
|---|---|---|---|
| 1 | Melt flow Index (MFI) | ISO 1133, 230° C./ | 17 g/10 min |
| | | 2.160 g | |
| 2 | Density | ISO 1183, A | 122 g/cm³ |
| 3 | Tensile strength at | ISO 527, 5 mm/min | 27 MPa |
| | yield | | |
| | Tensile modulus | ISO 527, 5 mm/mim | 2.200 MPa |
| | Elongation at break | ISO 527, 5 mm/min | 8.0% |
| 4 | Izod Impact strength, | ISO 180/1A | 24 J/m |
| | notched | | |

TABLE 6
Properties of the 50% PHB/50% PCL polymeric blend

| | Property/Test | Test method | Value |
|---|---|---|---|
| 1 | Melt flow Index (MFI) | ISO 1133, | 15 g/10 min |
| | | 230° C./2.160 g | |
| 2 | Density | ISO 1183, A | 1.22 g/cm³ |
| 3 | Tensile strength at yield | ISO 527, 5 mm/min | 27 MPa |
| | Tensile modulus | ISO 527, 5 mm/mim | 1.500 MPa |
| | Elongation at break | ISO 527, 5 mm/min | 40.0% |
| 4 | Izod Impact strength, | ISO 180/1A | 30 J/m |
| | notched (Izod Impact | | |
| | strength, notched) | | |

TABLE 7
Properties of the polymeric blend with 45% PHB/15% PCL,
modified with 40% of wood dust

| | Property/Test | Test method | Value |
|---|---|---|---|
| 1 | Melt flow Index - MFI | ISO 1133, | 8 g/10 min |
| | | 230° C./2.160 g | |
| 2 | Density | ISO 1183, A | 1.30 g/cm³ |
| 3 | Tensile strength at | ISO 527, 5 mm/min | 25 MPa |
| | yield | | |
| | Tensile modulus | ISO 527, 5 mm/mim | 4.700 MPa |
| | Elongation at break | ISO 527, 5 mm/min | 1.5% |
| 4 | Izod Impact | ISO 180/1A | 24 J/m |
| | strength, notched | | |

TABLE 8
Properties of the polymeric blend with 30% PHB/30% PCL,
modified with 40% of wood dust

| | Property/Test | Test method | Value |
|---|---|---|---|
| 1 | Melt flow Index - MFI | ISO 1133, | 6.5 g/10 min |
| | | 230° C./2.160 g | |
| 2 | Density | ISO 1183, A | 1.30 g/cm³ |
| 3 | Tensile strength at | ISO 527, 5 mm/min | 25 MPa |
| | yield | | |
| | Tensile modulus | ISO 527, 5 mm/mim | 3.800 MPa |
| | Elongation at break | ISO 527, 5 mm/min | 1.6% |
| 4 | Izod Impact strength, | ISO 180/1A | 28 J/m |
| | notched | | |

1. Environmentally degradable Polymeric blend, characterized in that it comprises a biodegradable polymer defined by Poly(hydroxybutyrate) (PHB) or copolymers thereof and Polycaprolactone—PCL; and, optionally, at least one of the additives defined by: plasticizer of natural origin, such as natural fibers; natural filler; thermal stabilizer; nucleant; compatibilizer; surface treatment additive; and processing aid.

2. Blend, as set forth in claim 1, characterized in that the plasticizer is a vegetable oil “in natura” (as found in nature) or derivative thereof, ester or epoxy, from soybean, corn, castor-oil plant, palm, coconut, peanut, linseed, sunflower, babasu palm, palm kernel, canola, olive, carnauba wax, tung, jojoba, grape seed, andiroba, almond, sweet almond, cotton, walnuts, wheatgerm, rice, macadamia, sesame, hazelnut, cocoa (butter), cashew nut, cupuacu, poppy and their possible hydrogenated derivatives, present a composition in a mass proportion lying from about 2% to about 30%, preferably from about 2% to about 15% and, more preferably, from about 5% to about 10%.

3. Blend, as set forth in claim 2, characterized in that the plasticizer has a fatty composition ranging from: 45-63% of linoleates, 2-4% of linoleinates, 1-4% of palmitates, 1-3% of palmitoleates, 12-29% of oleates, 5-12% of stearates, 2-6% of miristates, 20-35% of palmistate, 1-2% of gadoleates and 0.5-1.6% of behenates.

4. Blend, as set forth in claim 1, characterized in that the useful natural fibers are selected from: sisal, sugarcane bagasse, coconut, piasaba, soybean, jute, ramie, and curaua (Ananas lucidus), present in the composition in a mass proportion lying from about 5% to about 70% and, more preferably, from about 10% to about 60%.

5. Blend, as set forth in claim 1, characterized in that the useful natural filler or lignocellulosic are selected from: wood flour or wood dust; starches and rice husk; present in the composition in a mass proportion lying from about 5% to about 70% and, and preferably from about 10% to about 60%.

6. Blend, as set forth in claim 1, characterized in that the compatibilizer can be of the type: polyolefine functionalized or grafted, with maleic anhydride, ionomer based on ethylene acrylic acid or ethylene methacrylic acid copolymers, neutralized with sodium (trademark Surlin from DuPont), present in the composition in a mass proportion lying from about 0.01% to about 2%, preferably from about 0.05% to about 1%.

7. Blend, as set forth in claim 1, characterized in that the surface treatment agent can be of the type: silane; titanate; zirconate; epoxy resin; stearic acid and calcium stearate, present in the composition in a mass proportion lying from about 0.01% to about 2%.

8. Blend, as set forth in claim 1, characterized in that the processing aid is the product Struktol commercialized by Struktol Company of America, present in the composition in a mass proportion lying from about 0.01% to about 2%, preferably from about 0.05% to about 1%.

9. Blend, as set forth in claim 1, characterized in that the stabilizer can be primary antioxidant, secondary antioxidant, or ultraviolet stabilizers of the oligomeric HALS type (sterically hindered amine), present in the composition in a mass proportion lying from about 0.01% to about 2%, preferably from about 0.05% to about 1% and, more preferably, from about 0.1% to about 0.5%.

10. Process for obtaining an environmentally degradable polymeric blend, formed by Poly(hydroxybutyrate) or copolymers thereof; PHB or its copolymers—PHBV and Polycaprolactone—PCL and, optionally, at least one additive defined by: plasticizer of natural origin, such as natural fibers; natural filler; thermal stabilizer; nucleant; compatibilizer; surface treatment additive; and processing aid, characterized in that it comprises the steps:
a) pre-mixing the materials constituent of the composition of interest for uniformizing the length of the natural fibers, surface treating the natural fibers and/or the natural fillers;
b) drying said materials and extruding them, so as to obtain their granulation; and
c) injection molding the extruded and granulated material for the manufacture of several products.

11. Application of the environmentally degradable polymeric blend, formed by Poly(hydroxybutyrate)-PHB/Polycaprolactone—PCL, in the manufacture of injected food packages, injected packages for cosmetics, tubes, technical pieces and several injected products.
